(19) United States
(12) Patent Application Publication
(10) Pub. No.: US 2002/0028354 A1
(43) Pub. Date: Mar. 7, 2002

(54) Floppy disk and method for manufacturing the same

(75) Inventor: Kazuyuki Usuki, Odawara-shi (JP)

Correspondence Address: SUGHRUE, MION, ZINN, MACPEAK & SEAS, 2100 Pennsylvania Avenue, N.W., Washington, DC, 20037-3202, US

(73) Assignee: FUJI PHOTO FILM CO., LTD.

(21) Appl. No.: 09/871,731

(22) Filed: Jun. 4, 2001

(30) Foreign Application Priority Data
Jun. 5, 2000 (JP) 2000-167746

(51) Int. Cl. G11B 5/82

(52) U.S. Cl. 428/694 SL

(57) ABSTRACT

The present invention provides a floppy disk with high shape stability, and the invention provides a floppy disk, which comprises a magnetic layer containing a ferromagnetic metal thin film at least on one surface of a flexible support member, wherein the flexible support member comprising aromatic polyimide film, aromatic polyamide film, etc. is bonded together with a hot-melt adhesion sheet.

### BACKGROUND OF THE INVENTION

The present invention to a method for manufacturing a floppy disk with high recording density. In particular, the invention relates to a floppy disk medium, which comprises a support member having high dimensional stability, high heat-resistant property, low susceptibility to warping and smooth surface. The invention also to a method for manufacturing these products.

In a magnetic recording medium such as magnetic tape, hard disk, etc., a ferromagnetic metal thin film prepared by sputtering method or by film-forming method (e.g. vacuum deposition method) is used as a recording layer on a vacuum deposition tape or on a thin film type hard disk, and these are used in practical application as the magnetic recording medium. In this type of magnetic recording medium, high magnetic energy can be easily obtained. By smoothening the surface of nonmagnetic substrate further, smooth surface property can be easily attained. Thus, this is suitable as a high-density recording material because spacing loss is low and electromagnetic transfer characteristics are high. In particular, the magnetic layer produced by sputtering method can increase the magnetic energy more than the magnetic layer produced by vacuum deposition method, and this is adopted in the magnetic recording medium, which requires high recording density such as hard disk.

On the other hand, compared with hard disk, floppy disk type magnetic recording medium has higher shock-resistant property and can be produced at lower cost, and it is now widely used. Further, the present applicant has previously provided a coating type magnetic recording medium, which comprises a thin film magnetic layer formed by coating a magnetic coating material on a lower magnetic layer or on a lower nonmagnetic layer formed on a base material, i.e. a large-capacity medium of 200 MB or more per 3.5-type floppy disk. However, this recording density is still lower than 1/10 of that of a hard disk. This may be attributed to the fact that, despite of a number of attempts to produce a magnetic film by sputtering method as in the case of hard disk, it has not yet reached the level suitable for practical application.

There may be a number of reasons for this. One of the reasons is the difficulty to develop a support member suitable for such type of floppy disk. The support member of a floppy disk with a magnetic film produced by sputtering method must have the following four properties:

(1) Smooth Surface Property

When a magnetic recording medium is produced by sputtering method, surface property of the support member is directly reflected in the surface of the medium. To produce a magnetic recording medium with high recording density, it is necessary to prepare a support member with very smooth surface. More concretely, it is necessary to prepare a support member with maximum surface roughness Rmax of not more than 60 nm.

(2) High Heat-Resistant Property

A magnetic film for high density recording must have electromagnetic transfer characteristics such as high output and low noise. For this purpose, the film must be formed while the support member is being heated when the magnetic film is produced by sputtering method. Therefore, the support member must have very high heat-resistant property and it must be stable when it is heated without resulting in deformation and chemical change. More concretely, the support member must have a property to resist the heat of 200° C. or more.

(3) Less Susceptibility to Warping

To increase the transfer speed, a high-density floppy disk is subjected to sliding operation with very low flying height when it is brought into contact or nearly into contact with the magnetic head under high speed rotation as in the case of hard disk. When planar deviation occurs on the floppy disk, strong and violent contact with the head occurs, and sliding operation is turned to unstable, and this often leads to lower running durability and poor reliability. For this reason, planar deviation of the floppy disk must be reduced to the level of 50 μm or lower. Such planar deviation is under strong influence of warping, which the floppy disk undergoes statically.

This warping is either inherent in the support member or it occurs due to stress difference between front surface and rear surface during the manufacturing process of the medium. The warping developed during the manufacturing process can be adjusted by changing the manufacturing conditions. However, the warping inherent in the support member is difficult to adjust by changing the manufacturing conditions because the thickness of the support member is far greater than the thickness of the magnetic film. Moreover, when aromatic polyimide or aromatic polyamide film with high heat-resistant property is used as the support member, it is not possible to change and correct the shape by heating because the material has high heat-resistant property. For this reason, the support member must not have warping almost at all in static viewpoint. More concretely, when it is punched in form of a disk, warping must be reduced to not more than 1 mm.

(4) Dimensional Stability

With wide propagation of notebook-sized personal computers in recent years, the floppy disk is used very often in the personal computer. Temperature inside the notebook-sized personal computer is high, and it is often carried out of the room and may be used in wide temperature range. Under such conditions, the floppy disk must have high dimensional stability under diverse temperature conditions, and it must exhibit good tracking performance in stable manner. For this purpose, the support member must have high dimensional stability from thermal viewpoint.

It is very difficult to develop a support member, which satisfies the above four properties, and it is not yet commercially marketed.

For instance, in polyethylene terephthalate or polyethylene naphthalate, which is widely used in magnetic tape or the support member of floppy disk, glass transfer temperature is far lower than heating temperature when the magnetic layer is formed by sputtering method. As a result, deformation occurs when the magnetic layer is formed. Further, cracking develops very often on the magnetic layer. Also, when heated to this temperature level, surface property is decreased due to deposition of oligomer on the surface or mechanical property is decreased due to hydrolysis.

Heat-resistant resin film such as aromatic polyimide or aromatic polyamide has high heat-resistant property, but it is very difficult to produce the product with smooth surface and less susceptibility to warping. In case of polyamide film, it is difficult to produce a film with thickness of 50 μm or more. Aromatic polyimide film or aromatic polyamide film is expensive in cost, and this high cost is an important factor in the manufacturing price of the floppy disk.

Further, whatever material may be used to produce the support member, when a support member with smooth surface is produced, there arises the problem of difficulty to handle such as transport or winding-up of the support member. To solve this problem, it is necessary to form surface irregularities near the end surface of the support member with the purpose of preventing the adhesion of the support member to the transport member or rear surface. Even when such measures are taken, if the width of the support member is increased, the effect may be reduced, and it becomes difficult to handle.

In this respect, in order to produce the support member to meet the above requirements, it is necessary to process the existing film and to improve the properties as the support member. For this purpose, a method is designed to produce the support member, which is produced by laminating heat-resistant film such as aromatic polyimide or aromatic polyamide and bonding it to prepare a laminated member. When this method is used, even in case the film has warping, the warping can be extensively reduced by bonding the films in such manner that the warping can be offset. Also, there is no need to make both surfaces smooth. One surface may be formed as smooth as possible, while the other surface may be formed with some roughness to facilitate the handling. By bonding rough surfaces with each other, it is possible to produce a smooth support member.

However, when a method to use an epoxy type or a polyester type general-purpose adhesive agent to bond the films together is adopted, adhesive strength may be extremely reduced due to the heating when the magnetic film is formed. Or, volatile gas components may be generated as the result of thermal decomposition. Also, when it is dissolved in a solvent and is coated, air bubbles may be generated due to residual solvent in the adhesive layer.

In a method to laminate using heat-resistant thermosetting polyimide as the adhesive agent, the thermosetting polyimide is dissolved only in a specific type of solvent with high boiling point. It is difficult to completely remove this solvent, and air bubbles are generated on the adhesive surface during thermosetting process for the bonding. Also, there is a problem that large-scale processing system is required.

Further, when other type of heat-resistant thermosetting resin or thermoplastic resin is dissolved in a solvent and is coated and used as the adhesive agent, viscosity of the adhesive agent is high, and it is not possible to remove foreign objects through precision filtration of the adhesive agent. Thus, there is a problem that foreign objects are intermingled in the adhesive surface.

JP-08-249641 proposes a method to bond a film comprising a magnetic film with a base material film via an adhesive agent. In this method, it is difficult to produce a floppy disk, which requires coating process to form the adhesive layer and has less susceptibility to warping because foreign objects are intermingled in the adhesive surface and warping of the base material film exerts influence on the floppy disk.

To solve the above problems, it is an object of the present invention to provide a floppy disk, which has smooth surface, high heat-resistant property, less susceptibility to warping and high dimensional stability, and also to provide a method for manufacturing this type of floppy disk.

### SUMMARY OF THE INVENTION

The present invention provides a floppy disk, which comprises a magnetic layer containing a ferromagnetic metal thin film at least on one surface of a flexible support member, whereby the flexible support member is designed in such structure that two heat-resistant resin films are bonded together with a hot-melt adhesion sheet.

Also, the present invention provides a method for manufacturing a floppy disk, comprising the steps of forming a magnetic layer containing a ferromagnetic metal thin film by sputtering method at least on one surface of one film among two heat-resistant resin films, heating said two heat-resistant films under vacuum condition, removing moisture contained in the heat-resistant resin films, and bonding the heat-resistant films with a hot-melt adhesion sheet under vacuum condition.

Also, the present invention provides a method for manufacturing a floppy disk, comprising the steps of forming a magnetic layer containing a ferromagnetic metal thin film by sputtering method at least on one surface of one film among two heat-resistant resin films, and bonding the two heat-resistant films with a hot-melt adhesion sheet.

### BRIEF DESCRIPTION OF THE DRAWINGS

FIG. 1 is a drawing to explain a vacuum press machine used in the present invention; and

FIG. 2 is a drawing to explain a continuous laminator used in the present invention.

### DESCRIPTION OF THE PREFERRED EMBODIMENT

The heat-resistant resin films used in the present invention include heat-resistant resin films such as aromatic polyimide film, aromatic polyamide film, polyether ether ketone, polyether sulfone, polyether imide, polysulfone, polyphenylene sulfide, fluoro-resin, etc. Among these substances, it is preferable to use aromatic polyimide film or aromatic polyamide film from the viewpoint of heat-resistant property. This is because the surface of the substrate is subjected to high temperature due to the heating of substrate or heat of plasma during the sputtering of the magnetic film. If heat-resistant property is low, troubles may occur such as thermal deformation, release of thermally decomposed gas, deposition of oligomer, etc.

It is preferable that the surface of a support member of the heat-resistant film is as smooth as possible.

This is because the surface property of the floppy disk exerts strong influence on electromagnetic transfer characteristics.

More concretely, in case a primer layer is used as described later, surface roughness measured by an optical type surface roughness meter is preferably within 10 nm in average central line roughness Ra, or more preferably within 5 nm. Also, the height of projections measured by a feeler type surface toughness meter is preferably within 1 μm, or more preferably within 0.1μm.

In case the primer layer is not used, the surface roughness measured by optical type surface roughness meter is within 3 nm in central line average surface roughness Ra, or more preferably within 1 nm. The height of projections measured by feeler type surface roughness meter is preferably within 0.1 μm, or more preferably within 0.06 μm.

Contact surface of the heat-resistant resin film preferably has adequate roughness for the convenience of handling or adhesion. More concretely, surface roughness measured by optical surface roughness meter is within 10 nm in central line average surface roughness Ra, or more preferably within 5 nm. The height of projections measured by feeler type surface roughness meter is preferably within 1 μm, or more preferably within 0.1 μm.

As examples of the aromatic polyimide film, Eupilex (manufactured by Ube Industries, Ltd.), Apical (manufactured by Kanegafuchi Chemical Industry Co., Ltd.), or Capton (manufactured by Dupont-Toray Co., Ltd.) may be used. As examples of the aromatic polyamide film, Aramica (manufactured by Asahi Chemical Industry Co., Ltd.), Microtron (manufactured by Toray Industries, Inc.) may be used.

The thickness of the heat-resistant film is preferably within the range of 3 to 50 μm, or more preferably within the range of 10 to 25 μm.

A hot-melt adhesion sheet used in the present invention is a thermoplastic adhesion sheet not containing base material. This may be produced by heating the resin to melt, and by coating it on adhesion surface. Or, the resin may be coated on a release paper in advance and may be wound up in roll-like shape. This may be much easier to handle and use. Adhesion temperature is preferably within the range of 100° C. to 180° C. from the viewpoint of productivity. As the hot-melt adhesion sheet used in the present invention, polyester resin, polyolefin, polyurethane, polyamide, etc. may be used. Concrete examples of the adhesive agents are: Aronmelt series (manufactured by Toagosei Chemical Industry Co., Ltd.), Elfan series (manufactured by Nippon Matai Co., Ltd., Platiron series (manufactured by Nippon Rilsan Co., Ltd.) may be used.

The hot-melt adhesion sheet has low melting point and low heat-resistant property. For this reason, it is necessary to form a ferromagnetic metal thin film by sputtering method on one surface of the heat-resistant resin film in advance to bond the heat-resistant films with each other. When the heat-resistant films are bonded to each other at first, and then, ferromagnetic metal thin film is provided on the support member, adhesive agent may be melted, and this may cause extreme deformation of the support member.

This hot-melt adhesion sheet is used by heating and pressing as described later, and the adhesion sheet with common surface roughness may be used. The thickness of the adhesive agent is preferably in the range of 10 to 100 μm, or more preferably in the range of 20 to 60 μm.

To bond the films and the sheet together, the hot-melt adhesion sheet is laminated so that the surface of the heat-resistant resin film to form the magnetic layer is on outer side, and this is heated and pressed. For adhesion, heat plate press or lamination by heat laminating rolls may be used. Above all, it is preferable to use heat plate press under vacuum condition or lamination by heat laminating rolls under vacuum condition. The temperature during this process varies according to the type of the hot-melt adhesive agent. In general, it is in the range of 100° C. to 180° C. When adhesion is performed under vacuum condition, the degree of vacuum should be selected in such manner that air bubbles may not be generated on the adhesion surface. The degree of vacuum is preferably not more than 1.33 kPa (10 Torr), or more preferably not more than 667 Pa (5 Torr).

In the present invention, moisture contained in the heat-resistant resin film such as aromatic polyamide, aromatic polyimide, polyether imide, etc. exerts extensive influence. These resins contain about 2 weight % of moisture at maximum. The adhesion temperature of the hot-melt adhesion sheet is in the range of 100° C. to 180° C. as described above. When these heat-resistant resin films are heated to this temperature, a large amount of moisture is released from the films. For this reason, when the hot-melt adhesion sheet and aromatic polyimide are directly heated to laminate using the heat laminating rolls, vapor may be blown to the molten hot-melt adhesive agent, and air bubbles may be generated. Therefore, to bond the films and the sheet together without generating air bubbles, it is necessary to completely dry the heat-resistant resin films before adhesion. The drying temperature is preferably within the range from the adhesion temperature to the temperature by 100° C. higher than the adhesion temperature.

When adhesion or bonding is performed by the heat plate press, the heat-resistant resin films and the hot-melt adhesion sheet with the release paper are placed one upon another, and the hot-melt adhesion sheet is attached on one of the heat-resistant resin films by heating and pressing. Then, the release paper of the adhesive agent is peeled off, and the other heat-resistant film is attached on it. The adhesion process may be performed one by one, while two or more films may be placed one upon another and these may be pressed at one time. These methods are low in productivity but it is possible to equalize distribution of heat and stress on the front and the rear surfaces, and a support member with less warping can be produced. In this case, it is preferable to press under vacuum condition in order to prevent generation of air bubbles on the adhesion surface or to avoid attachment of dust to each of the films. It is preferable that the surface of the press is smoother than that of the support member. If the surface of the press is too rough, the surface roughness may be transferred to the surface of the support member, and the surface of the support member may become rough. Further, to prevent the adhesion of the support member after attachment, it is preferable that the surface of the press is processed with surface treatment such as fluorine processing. The adequate applied pressure is preferably in the range of 981 Pa to 981 kPa (0.01 to 10 kgf/cm²).

In case the lamination is formed by laminating rolls, hot-melt adhesion sheet with the release paper is bounded to adhesion surface of one of the heat-resistant resin films. Next, after the release paper has been peeled off, the other heat-resistant resin film is bonded. For this bonding, the sheets may be bonded together on batch basis one by one, or the sheet may be continuously laminated from roll to roll. When lamination is performed on batch basis, the films are placed on a smooth plate one upon another, and the laminating rolls are pressed on it to press and bond together, or the heat-resistant resin film and the hot-melt adhesion sheet are passed between the laminating rolls. When continuous laminating is performed using rolls, the heat-resistant film and the hot-melt adhesion sheet are passed between the laminating rolls. In both of the batch method or the continuous method, roll surface is preferably smoother than the surface of the support member. If it has rough surface, the surface roughness is transferred to the support member, and the support member will have rough surface. Further, it is preferable to perform the laminating process under vacuum condition in order to avoid generation of air bubbles on the adhesion surface or to prevent adhesion of dust on films. The pressure of the laminating rolls is preferably in the range of 981 Pa to 981 kPa (0.01 to 10 kgf/cm²).

Next, description will be given on the primer film used in the present invention.

In case surface property of the heat-resistant resin film is not good enough, it is preferable to use a primer film with the purpose of smoothening the surface of the heat-resistant resin film. The primer film must have heat-resistant property similar to the heat-resistant resin film, and polyimide resin, polyamideimide resin, silicone resin, fluoro-resin, etc. must be used. Polyester resin as commonly in use cannot be adopted. Above all, as the material of the primer film, thermosetting imide or thermosetting silicone resin with high smoothening effect is preferably used. The thickness of the primer film is preferably in the range of 0.1 to 3 μm. The primer film may be prepared prior to the bonding of the heat-resistant resin film with the thermosetting resin film or may be prepared thereafter.

As an example to use the thermosetting imide resin as described above, polyimide resin thermally polymerized from imide monomer having two or more terminal unsaturated groups in the molecule may be used. As an example of such imide monomer, bisallylnadiimide expressed by the following chemical formula 1 may be used:

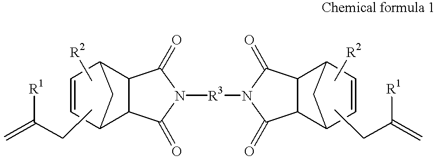

wherein R¹ and R² each represents an independently selected hydrogen or methyl group, and R³ is a bivalent bonding group such as aliphatic or aromatic hydrocarbon group.

The thermosetting polyimide resin preferably used in the present invention is prepared not by adding polyimide already polymerized but it is a polyimide produced by adding imide monomer to the heat-resistant resin film and then processed by thermal polymerization. In this monomer, imide cyclization is already completed and it has two or more terminal unsaturated groups in the molecule. Polymerization reaction to polyimide proceeds by addition polymerization of vinyl group by heating. Therefore, polymerization reaction occurs at relatively low temperature, and polyimide can be added to various types of nonmagnetic support member. Imide monomer is soluble in general-purpose organic solvents because of its structure, and it has high productivity and workability. Also, imide monomer naturally has lower molecular weight than polyimide, and its solution has low viscosity. When this is coated on a nonmagnetic support member, it is easily adapted for and covers surface roughness and has high smoothening effect.

As the imide monomer compound having such imide cycle and two or more terminal unsaturated bondings, the compound already known and produced by the synthetic method already known as described in JP-59-080662, JP-60178862, JP-61018761, JP-63170358, JP-07-53516, etc. may be used.

In the compound 1, R¹ and R² each represents independently selected hydrogen or methyl group, and R³ represents a bivalent bonding group of aliphatic or aromatic compound, and there is no specific restriction. For instance, direct-chain or branched alkylene group or alkenyl group, cycloalkylene group, cycloalkylene group having alkylene group, aromatic group, aromatic group having alkylene group, polyoxyalkylene group, carbonyl group, ether group, etc. may be used.

The solubility of imide monomer in solvent and the heat-resistant property of polyimide resin, which is a polymerization product of imide monomer, are primarily determined by the structure of R³. For this reason, the desired property is achieved by selecting the structure of R³.

Such compounds are commercially marketed by Maruzen Petrochemical Co., Ltd. as BANI series or ANI series products.

The primer film in the present invention may contain components other than imide monomer. For instance, it may contain a curing agent to promote polymerization, heat-resistant particles (filler) to provide surface roughness, a coupling agent to improve tight bonding, or a rust-preventive agent to prevent oxidation of the magnetic film.

As the curing agent; p-toluene sulfonic acid, p-xylene sulfonic acid, toluene methyl sulfonate, pyridinium-p-toluene sulfonate, pyridinium-m-nitrobenzene sulfonate, methylhydrazine sulfate, etc. may be used.

The coating solvent varies according to the type of R³ in the chemical formula 1. In many structures, it is soluble in toluene, xylene, acetonitrile, cyclohexanone, methyl ethyl ketone, acetone, etc. In some of the structures, it is also soluble in isopropyl alcohol, ethanol, methanol, etc. Also, mixture solution of these compounds may be used as the solvent.

As an example of the thermosetting silicone resin preferably used in the present invention, silicone resin prepared by sol-gel method using silicon compound as raw material may be used. Such silicone resin comprises a structure by substituting a part of silicon dioxide bonding by an organic group, and this has far higher heat resistant property than silicone rubber. Also, it has higher flexibility than silicon dioxide film. When this is used on a flexible film such as the heat-resistant resin film, cracking or peeling hardly occurs.

The monomer used as the raw material is directly coated on the heat-resistant resin film and is cured. As a result, a general-purpose solvent can be used, and it is easily adapted to surface roughness and has high smoothening effect. Further, condensation and polymerization reaction occurs from relatively low temperature by adding a catalyst such as acid or chelating agent, and curing can be achieved within short time. For this reason, it can be prepared using a general-purpose coating device.

As the monomer used as the raw material of the thermosetting silicone resin, silane coupling agent having aromatic hydrocarbon group, organic residual group containing aliphatic or epoxy group may be used. The aromatic hydrocarbon group or the aliphatic hydrocarbon group has an effect to add flexibility in the cured resin. In particular, the silane coupling agent having aromatic hydrocarbon group has aliphatic hydrocarbon group introduced in it, and it is preferably used because of high heat-resistant property. Also, the silane coupling agent containing epoxy group has an effect to harden the coating film from relatively low temperature.

For instance, silane coupling agent containing aromatic hydrocarbon group has a structure expressed by the following chemical formula 2:

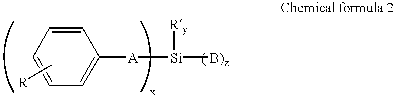

where R and R′ each represents a monovalent organic group such as methyl group, the symbol A represents a bivalent organic group such as alkylene group or without such group (direct-coupled), and the symbol B represents a monovalent group (X+Y+Z=4) such as alkoxy group, halogen, hydroxyl group, etc.

In the chemical formula 2, the symbol A preferably represents none, or a methylene group.

The symbol B preferably represents an alkoxy group when reactivity or corrosion property to magnetic film is taken into account. It is preferably an alkoxy group having 4 or less carbon atoms such as methoxy group because this facilitates polymerization reaction. X preferably represents 1 or 2. In particular, it is preferably 1 to facilitate polymerization reaction. Y preferably represents 0 or 1, or more preferably 0 to facilitate polymerization reaction. Therefore, Z is preferably 3.

As concrete examples, the substances expressed by the following formulae may be used.

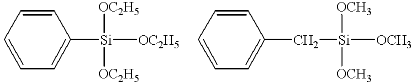

Silane coupling agent containing organic residual group having epoxy group has a structure, for instance, expressed by the following chemical formula 3:

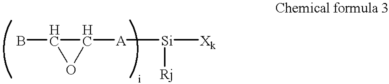

where the symbol A presents a bivalent organic residual group such as alkylene group;

The symbol B represents hydrogen or a monovalent organic residual group such as alkyl group;

R represents a monovalent organic residual group such as alkyl group;

X represents a monovalent group selected from alkoxy group, hydroxyl group, halogen or hydrogen; and

i+j+k=4

In the structure of the chemical formula 3, the symbol A preferably represents hydrogen. R represents a monovalent organic residual group such as methyl group or an ethyl group. X preferably represents an alkoxy group when reactivity or corrosion property to the magnetic film is taken into account. To facilitate polymerization reaction, it is preferably an alkoxy group having 4 carbon atoms or less such as methoxy group. M preferably represents 1 or 2, or more preferably 1 to facilitate polymerization reaction. L preferably represents 0 or 1, or more preferably 0 to facilitate polymerization reaction. Therefore, N preferably represents 3.

As the compounds as described above, those expressed by the chemical formula given below may be used. These compounds are described in JP-51-011871 or JP-63-023224.

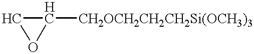

Also, for the purpose of providing heat-resistant property, of producing at low cost, and of adjusting polymerization rate, a silane coupling agent containing hydrocarbon group such as methyl group may be mixed and used. When the silane coupling agent containing hydrocarbon is simultaneously used, heat-resistant property of the primer film may be improved. More concretely, the silane coupling agent containing the hydrocarbon group has the following structure:

R—Si(OR′)₃

where R and R′ each represents a hydrocarbon group, and the fewer the number of carbon atoms in R is, the more effective it is for the improvement of heat-resistant property of the primer film.

When the silane coupling agent having aromatic hydrocarbon group or the silane coupling agent containing organic residual group having epoxy group is coated and dried, the portion of the coupling agent such as alkoxysilane is subjected to hydrolysis and polymerization and siloxane bonding is generated. On the other hand, epoxy group is subjected to ring opening polymerization due to acid catalyst or heat. The rate of hydrolysis and polymerization can be adjusted by adding acid such as hydrochloric acid as necessary.

To start the polymerization from lower temperature, it is preferable to simultaneously use the curing agent. For instance, various types of compounds are known such as metal chelating compound, organic acid and its salt, perchlorate, etc. As the curing agent, it is preferable to use metal chelating compound from the reasons such as curing at low temperature and corrosion to the magnetic film. For instance, when aluminum acetyl acetonate is added as curing catalyst to 3-glycidoxypropyltrimethoxy-silane, curing occurs simply by heating at around 100° C. for short time. For this reason, blocking does not occur, and by gravure continuous coating method, it can be wound up without inducing blocking. The following compounds are particularly effective as the curing agent: β-diketone such as aluminum acetyl acetonate, zirconium acetyl acetonate, titanium acetyl acetonate, etc., and chelating compound of metal. The coating solvent to be used for this purpose is determined according to adding quantity of hydrochloric acid or structure of silane coupling agent, and ethanol, methanol, isopropyl alcohol, cyclohexanone, etc. may be used.

In the present invention, the primer film comprising the thermosetting polyimide resin layer or the thermosetting silicone resin layer as described above is prepared on the heat-resistant resin film by the following procedure: By adding the monomer used as raw material and curing agent when necessary, it is dissolved in organic solvent to prepare a coating solution, and this is coated on the heat-resistant resin film by the methods such as wire bar method, gravure method, spray method, dip coating method, spin coating method, etc, and then, it is dried. Thereafter, the primer film is fired as necessary to promote the curing, and heat-resistant property, resistance to solvent, and adhesion property can be improved. The drying is performed with the purpose of evaporating the solvent, and curing can also be performed at the same time. As the drying method, the method commonly in use such as hot air drying, infrared drying, etc. may be used.

After the coating film has been dried, hot air heating, infrared heating, heat roller heating, etc. may be used to promote the curing. In this case, the heating temperature varies in each case according to thickness of the coating film, and to the method to form the magnetic film or to the film forming temperature. In case the thickness is about 1 μm, the heating temperature is in the range of 100° C. to 350° C., or more preferably in the range of 200° C. to 270° C. If the temperature is lower than the above range, the progress of polymerization reaction may not be sufficient, or residual gas or decomposing gas may be generated during the sputtering of the magnetic film, and this may hinder crystal growth of the magnetic film. On the contrary, if it is too high, the support member may be deformed or productivity may be reduced.

In addition to the polymerization due to heating, polymerization reaction may be performed by UV irradiation or electron beam irradiation instead of heating in case of the material, for which polymerization can be achieved by such irradiation.

Also, by providing micro-projections with very low height on the surface of the primer film, it is possible to reduce the true contact area between the magnetic recording medium and the sliding member and to improve sliding characteristics. Hence, it is preferable to provide micro-projection structure on the surface of the magnetic film on the base material. This micro-projection structure has also an effect to extensively increase handling property of the support member after adhesion.

As the methods to prepare the micro-projection structure, there are a method to coat spherical silica particles, a method to form projections of organic substances by coating emulsion, etc. To ensure heat-resistant property, it is preferable to use silica particles. To fix the projections on the surface of the film, a binder may be used, while it is preferable to use resin having sufficient heat-resistant property. As such materials, it is preferable to use thermosetting imide or thermosetting silicone resin used as adhesive agent in the present invention. The height of micro-projection is preferably in the range of 5 to 60 nm, or more preferably 10 to 30 nm. Its density is preferably 0.1 to 100 projections/μm². If the height of micro-projections is too high, electromagnetic transfer characteristics are decreased due to spacing loss between the recording and reproducing head and the medium. If micro-projections are too low, the effect to improve sliding property is decreased. If the density of micro-projections is too low, the effect to improve sliding property is decreased. If the density is too high, high projections are increased with the increase of aggregated particles, and electromagnetic transfer characteristics are decreased.

The thickness of the coating film of the binder is preferably not more than 20 nm. If the binder is too thick, blocking with the rear surface of the film may occur after drying.

The ferromagnetic metal thin film used as the magnetic layer of the floppy disk according to the present invention is produced by sputtering method or by vacuum deposition method.

As the composition of the magnetic layer, metal or alloy containing cobalt as main component is used. More concretely, Co—Cr, Co—Ni—Cr, Co—Cr—Ta, Co—Cr—Pt, Co—Cr—Ta—Pt, Co—Cr—Pt—Si, Co—Cr—Pt—B, Co—O, etc. may be used. In particular, to improve electromagnetic transfer characteristics, it is preferable to use Co—Cr—Pt or Co—Cr—Pt—Ta. The thickness of the magnetic layer is preferably in the range of 10 to 30 nm.

In this case, it is preferable to provide a primer layer to improve static magnetic property of the magnetic layer. As the composition of this primer layer, it is preferable to use metal or alloy. More concretely, Cr, V, Ti, Ta, W, Si, etc. or an alloy of these metals may be used. Above all, it is preferable to use Ta, Ni—P, Ni—Al, or Cr—Ti. The thickness of the primer layer is preferably in the range of 5 to 50 nm, or more preferably 10 to 30 nm.

Further, to control crystal orientation of the primer layer, it is preferable to use a seed layer under the primer layer. More concretely, Ta, Mo, W, V, Zr, Cr, Rh, Hf, Nb, Mn, Ni, Al, Ru or Ti or an alloy of these elements may be used. More preferably, Ta, Cr or Ti or an alloy of these elements may be used. The thickness is preferably in the range of 15 to 60 nm. Unlike the primer layer, these are used in amorphous state or in the state with smaller crystallite than the primer layer.

Further, to increase adhesion property between the primer film and the seed layer, an adhesive layer may be provided. In case the seed layer is not formed, the adhesive layer may be introduced to increase adhesion between the primer film and the primer layer. As the adhesion layer, Cr, V, T, Ta, W, Si, etc. or an alloy of these elements may be used.

When the magnetic layer is prepared by the sputtering method, it is preferable to form the film while the support member is heated. DC or RF magnetron sputtering method is used, and the temperature of the support member is preferably in the range of 100° C. to 250° C. On the other hand, special care must taken because the support member is heated not only by heating but also by the heat during the sputtering.

In the magnetic recording medium of the present invention, it is preferable to provide a protective film on the ferromagnetic metal thin film. By this protective film, it is possible to extensively improve running durability and corrosion-resistant property. As the protective film, oxides such as silica, alumina, titania, zirconia, cobalt oxide, nickel oxide, etc., nitrides such as titanium nitride, silicon nitride, boron nitride, etc., carbide such as silicon carbide, chromium carbide, boron carbide, etc., carbon such as graphite, amorphous carbon, etc. may be used. The protective film preferably has hardness equal to or higher than the material of the head. Further, it is preferably less susceptible to seizure during sliding operation and has long-lasting and stable effect. As such protective film, a hard carbon film called diamond-like carbon (DLC) may be used.

The diamond-like carbon film is an amorphous carbon film produced by plasma CVD method, sputtering method, etc. Microscopically, it is a mixture of a cluster on sp² combination and a cluster on sp³ combination. The hardness of this film is preferably 10×10³ MPa or more in Vickers hardness, or more preferably 20×10³ MPa or more. When the diamond-like carbon film is measured by Raman spectroanalysis, a main peak called G-peak is found near 1540 cm⁻¹, and a shoulder called D-peak is detected at 1390 cm⁻¹. The diamond-like carbon film can be produced by sputtering method or by CVD method. From the viewpoints of productivity, stability in product quality and high wear-resistant property even in case of ultra-thin film with thickness of 10 nm or less, it is preferable to produce it by CVD method. In particular, it is preferable to adopt the method to use chemical species produced by decomposing carbon-containing compounds such as alkane including methane, ethane, propane, butane, etc. by plasma, or alkene such as ethylene propylene, etc. or alkyne such as acetylene. This chemical species is further processed by applying negative bias voltage on the magnetic film or on a pole before the magnetic film.

Further, nitrogen gas is mixed with the raw material gas, and it is turned to a diamond-like carbon containing C, H, and N. As a result, friction coefficient to the head can be decreased. If the hard carbon protective film is too thick, electromagnetic transfer characteristics may be decreased or adhesion property to the magnetic layer may be decreased. If it is too thin, wear resistance is not high enough. Thus, the thickness is preferably in the range of 2 to 30 nm, or more preferably 5 to 20 nm.

In the magnetic recording medium of the present invention, it is preferable to add lubricant or rust-preventive agent to the magnetic film or the protective film with the purpose of improving running durability and corrosion-resistant property.

As the lubricant, hydrocarbon type lubricant, fluorine type lubricant, extreme-pressure additive, etc. may be used.

As the hydrocarbon type lubricant, carboxylic acids such as stearic acid, oleic acid, etc., esters such as butyl stearate, sulfonic acids such as octadecyl sulfonic acid, etc., phosphoric acid ester such as monooctadecyl phosphate, alcohols such as oleyl alcohol, carboxylic acid amides such as stearic acid amide, etc., or amines such as stearyl amine may be used.

As the fluorine type lubricant, a lubricant may be used, which is obtained by substituting a part or all of alkyl groups of the hydrocarbon type lubricant with fluoroalkyl group or perfluoropolyether group. Perfluropolyether groups include perfluoromethylene oxide polymer, perfluoroethylene oxide polymer, perfluoro-n-propylene oxide polymer (CF₂CF₂CF₂O)ₙ, perfluoro-isopropylene oxide polymer (CF(CF₃)CF₂O)ₙ, or copolymer of these compounds. More concretely, perfluoromethylene-perfluoroethylene copolymer having hydroxyl group at the molecule terminal (e.g. Fomblin Z-Dol) may be used.

As the extreme-pressure additive, phosphoric acid esters such as trilauryl phosphate, phosphorous acid esters such as trilauryl phosphite, thiophosphorous acid ester such as trilauryl trithiophosphite, etc., sulfur type extreme-pressure additive such as dibenzyl disulfide, etc. may be used.

The above lubricants may be used in combination or alone. To add these lubricants on the magnetic film or the protective film, the lubricant is dissolved in an organic solvent, and is coated by wire bar method, gravure method, spin coating method, or dip coating method, or may be deposited by vacuum deposition method.

Coating quantity of the lubricant is preferably in the range of 1 to 30 mg/m², or more preferably 2 to 20 mg/m².

As the rust-preventive agent used in the present invention, nitrogen-containing heterocyclic compounds such as benzotriazole, benzimidazole, purine, pyrimidine, etc. and derivatives obtained by introducing alkyl side-chain to mother nucleus of these compounds, nitrogen or sulfur-containing heterocyclic compounds such as benzothiazole, 2-mercaptobenzothiazole, tetrazaindene cyclic compound, thiouracil compound and the derivatives may be used. These compounds may be mixed in the lubricant and may be coated on the protective film, or may be coated on the protective film before coating the lubricant, and the lubricant may be coated on it. The coating quantity of the rust-preventive agent is preferably in the range of 1 to 10 mg/m², or more preferably 0.5 to 5 mg/m².

As tetrazaindene cyclic compound to be used for this purpose, the following compound may be used:

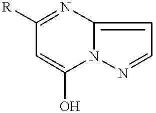

where R represents a hydrocarbon group selected from alkyl group, alkoxy group, or alkylamide group.

More preferably, it contains 3 to 20 carbon atoms. In case of alkoxy group, R⁴ in R⁴OCOCH₂— represents C₃H₇—, C₆H₁₃—, or phenyl, In case of alkyl group, it represents C₆H₁₃—, or C₉H₁₉—, or C₁₇H₃₅—. In case of alkyl amide, R⁵ in R⁵NHCOCH₂— represents phenyl or C₃H₇—.

As thiouracil cyclic compound, the following compound may be used:

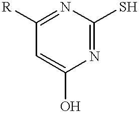

where R represents the same group as in the tetrazaindene cyclic compound as given above.

Description will be given below on some examples to explain the features of the present invention:

### EXAMPLE 1

A solution was prepared by dissolving thermosetting imide resin (manufactured by Maruzen Petrochemical Co., Ltd.; BANI-NB) in cyclohexane-ethanol mixed solvent. This solution was coated by dip coating method on both surfaces of a heat-resistant resin film comprising aromatic polyamide of 80 nm in maximum projection roughness Rₘₐₓ on the magnetic surface, 1.2 nm in average central line roughness Ra, and 25 μm in thickness. After this was dried at room temperature, it was heated at 250° C. for one hour, and a primer film of 1.0 μm in thickness was prepared. Further, silica particles of 25 nm in thickness and cyclohexanone solution of thermosetting imide resin were coated. This was dried at 250° C. for one hour, and micro-projections with average projection height of about 20 nm and projection density of 3 projections/μm² were prepared.

Next, this film was cut and was sandwiched and fixed using a circular holder under uniform tensile strength. This was placed in a sputtering system for forming magnetic film. The support member was heated at 200° C., and a Cr—Ti primer film was formed in thickness of 30 nm by DC magnetron sputtering method. Further, a Co—Cr—Pt magnetic film was formed in thickness of 30 nm.

The primer film and the magnetic film were formed on one surface of the support member. Further, this specimen was removed from the sputtering system, and a diamond-like carbon protective film of 15 nm in thickness was formed on the magnetic film by plasma CVD method using ethane as raw material.

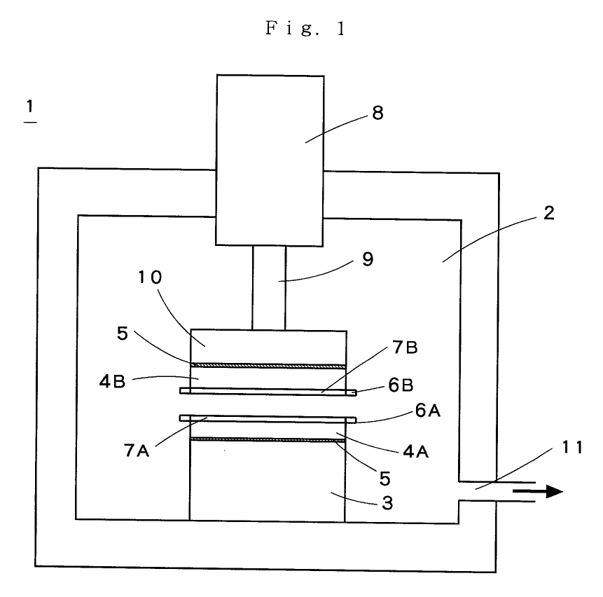

Two aromatic polyamide films with the magnetic film were prepared. On one of the films, lamination was formed using a vacuum plate press as shown in FIG. 1.

The vacuum plane press 1 shown in FIG. 1 comprises a specimen stand 3 in a vacuum chamber 2. On the specimen stand, a lower mirror-polished stainless steel plate 4A with electric heater in it was disposed via a silicone rubber 5. On the lower mirror-polished stainless steel plate 4A, a lower specimen 7A was mounted using a lower specimen retaining ring 6A. On the other hand, a pressure plate 10 was mounted on a pressure shaft 9 of a pressure cylinder 8. On the pressure plate 10, an upper mirror-polished stainless steel plate 4B with electric heater was mounted via a silicone rubber 5. On the upper mirror-polished stainless steel plate 4B, an upper specimen 7B was mounted via an upper specimen retaining ring 6B.

In the vacuum plate press 1, the film was fixed on hot plate of the upper mirror-polished stainless steel plate 4B with the electric heater to bring the magnetic surface in contact with the hot plate. Then, a hot-melt adhesion sheet (Aronmelt PES111EE; manufactured by Toagosei Chemical Industry Co., Ltd.) was fixed on the lower mirror-polished stainless steel plate 4A with electric heater so that the release paper was brought in contact with the hot plate. Under this condition, air was exhausted to reach the degree of vacuum of 667 Pa (5 Torr). The upper mirror-polished stainless steel plate 4B was heated to 200° C. and was maintained for one minute, and aromatic polyamide film was dried.

Next, the upper mirror-polished stainless steel plate was set to 150° C. and the lower mirror-polished stainless steel plate was set to 100° C. The aromatic polyamide film and the hot-melt adhesion sheet were pressed together under pressure of 0.2 kg/cm² for 10 seconds. After bonding them together, the film was brought into the atmospheric air, and the release paper of the hot-melt adhesion sheet was peeled off. Then, under the same conditions, drying and adhesion of the other aromatic polyimide film was performed using the vacuum plate press.

Further, perfluoro-polyether type lubricant (Fomblin Z-Dol; Ausimont Co., Ltd.) was dissolved in a fluorine type solution (FC-77; Sumitomo 3M Co., Ltd.), and this solution was coated on the protective film of this specimen by dip coating method, and a lubricant film of 1 nm in thickness was prepared. This specimen was punched in form of 3.7-type magnetic disk, and a floppy disk was prepared.

### EXAMPLE 2

A specimen was prepared by the same procedure as in Example 1 except that an aromatic polyimide film of 0.2 μm in maximum projection roughness Rmax on the magnetic surface, 2.0 nm in average central line roughness Ra, and 25 μm in thickness was used as the heat-resistant resin film, and a hot-melt adhesion sheet (Platiron H; manufactured by Nippon Rilsan Co., Ltd.) was used.

### EXAMPLE 3

An aromatic polyamide film in form of roll of 80 nm in maximum projection roughness Rmax on the magnetic surface, 1.2 nm in average central line roughness Ra, 25 μm in thickness and 30 cm in width was placed on a continuous winding type gravure coater. A coating solution with the following composition was coated on it by gravure coating method:

| | |
|---|---|
| 3-glycidoxypropyltrimethoxysilane | 20.0 weight % |
| Phenyltriethoxysilane | 20.0 weight % |
| Ethanol | 44.6 weight % |
| Cyclohexanone | 0.6 weight % |
| Purified water | 10.0 weight % |
| Hydrochloric acid (1 mol/l) | 4.4 weight % |
| Aluminum acetyl acetonate | 0.4 weight % |

This was dried and hardened at 120° C., and a primer film of 0.6 μm in thickness comprising thermosetting silicone resin was prepared and wound up. Further, on the primer film, silica particles of 25 nm in diameter and ethanol-cyclohexanone solution of the thermosetting silicone resin were coated, and this was dried at 120° C., and micro-projections with average projection height of 20 nm and projection density of 3 projections/μm² were prepared. This primer film was brought into contact with hot rollers heated at 170° C. and was moved at a rate of 0.1 m/sec. to harden the primer film, and the film was wound up.

A support member with this primer film was placed on a continuous film-forming type sputtering system. By moving the support member at a rate of 60 cm/min., a Cr—Ti primer film was formed in thickness of 30 nm, a Co—Cr—Pt magnetic film was formed in thickness of 30 nm, and a carbon protective film was formed in thickness of 20 nm on the magnetic surface of the aromatic polyamide film on a heated can heated to 150° C. by DC magnetron sputtering method. Then, the films were wound up.

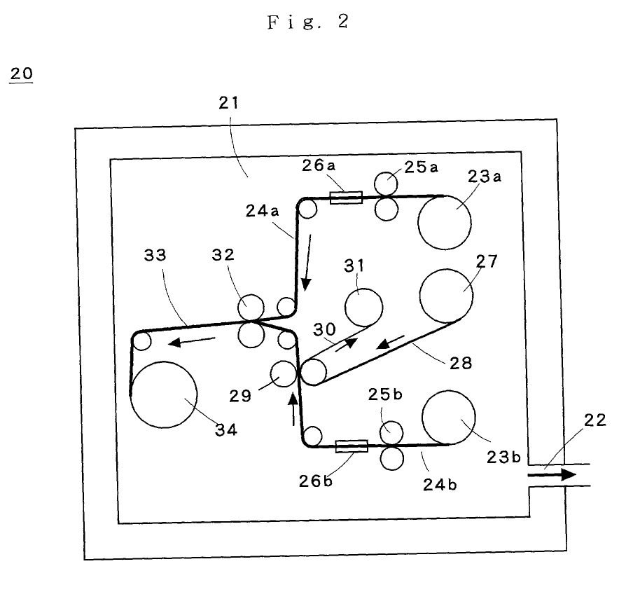

Next, two rolls of the specimens with the magnetic film and one roll of the hot-melt adhesion sheet roll (Aronmelt PES111EE; manufactured by Toagosei Chemical Industry Co., Ltd.) were placed on a continuous laminator as shown in FIG. 2.

In the continuous laminator 20 shown in FIG. 2, a vacuum pump was connected to an exhaust outlet 22, and the pressure in a vacuum chamber 21 was reduced. From heat-resistant resin film feeding rolls 23a and 23b, heat-resistant resin films 24a and 24b with magnetic layers were fed respectively. These were dried by hot rolls 25a and 25b and by lamp heaters 26a and 26b respectively. Then, a hot-melt adhesion sheet 28 laminated on the release paper was fed from a hot-melt adhesion sheet feeding roll 27. An adhesive layer of the hot-melt adhesion sheet was bonded to the heat-resistant resin film 24b by the first laminating roll 29. Then, a release paper 30 was wound up on a release paper wind-up roll 31. The heat-resistant resin films 24a and 24b and the hot-melt adhesion sheet 28 were fed by pressing from above and below by a second laminating roll 32. The laminated specimen 33 comprising the heat-resistant resin films 24a and 24b and the hot-melt adhesion sheet 28 was bonded together and wound up by the specimen wind-up roll 34, and the films and the sheet were continuously laminated.

The temperature of hot rolls for drying was set to 200° C., and the degree of vacuum was set to 667 Pa (5 Torr). The temperature of the laminating rolls was set to 150° C., and linear pressure of 490 N/m (0.5 kgf/cm) was applied on the laminating rolls, and the films and the sheet were moved at a rate of 0.1 m/sec., and these were bonded together.

Next, this specimen was placed on a continuous gravure coating device. A solution was prepared by dissolving perfluoropolyether lubricant (Fomblin Z-Dol; Ausimont Co., Ltd.) in a fluorine type solvent (FC-77; manufactured by Sumitomo 3M Co., Ltd.). This solution was coated on the protective films on both surfaces of the specimen, and lubricant film of 1 nm in thickness was prepared and this was wound up. This specimen was punched in form of 3.7-type magnetic disk, and a floppy disk was prepared.

### Comparative Example

A solution was prepared by dissolving thermosetting imide resin (BANI-NB; manufactured by Maruzen Petrochemical Co., Ltd.) in cyclohexane-ethanol mixed solvent. The above solution was coated by dip coating method on the surface of an aromatic polyimide film of 0.2 μm in maximum projection roughness Rmax on the smooth surface, 2.0 nm in average central line roughness Ra, 0.2 μm in surface roughness Rmax, and 2.9 μm in Ra and 50 μm in thickness, and this was dried at room temperature. Then, this was heated at 250° C. for one hour, and a primer film of 1.0 μm in thickness was prepared. Further, silica particles of 25 nm in diameter and cyclohexanone solution of thermosetting imide resin were coated on it, and this was dried at 250° C. for one hour, and micro-projections with average projection height of 20 nm and projection density of 3 projections/μm² were formed.

Next, this support member 7B was cut out and was sandwiched and fixed using a circular holder under uniform tensile strength, and this was placed on a sputtering system for forming the magnetic film. The support member was heated at 200° C., and a Cr—Ti primer film was formed in thickness of 30 nm by DC magnetron sputtering method. Further, a Co—Cr—Pt magnetic film in thickness of 30 nm was prepared.

The primer film and the magnetic film were formed on both surfaces of the support member. Further, this specimen was taken out of the sputtering system, and a diamond-like carbon protective film of 15 nm in thickness was formed on the magnetic film by plasma CVD method using ethane as raw material.

Next, the specimen was taken out of the holder. A solution was prepared by dissolving perfluoropolyether lubricant (Fomblin Z-Dol; Ausimont Co., Ltd.) in a fluorine type solvent (FC-77; Sumitomo 3M Co., Ltd.). This solution was coated on the protective film by dip coating method, and a lubricant film of 1 nm in thickness was prepared. This specimen was punched in form of a 3.7-type magnetic disk, and a floppy disk was prepared.

The specimens thus prepared were evaluated by the following evaluation methods:

Evaluation Methods

(1) External Appearance

The support member and the floppy disk in each of the examples were examined visually and under optical microscope (100×) to find whether foreign objects were caught in the surface of the support member and the adhesion surface, and whether air bubbles were generated or not.

(2) Curl Value

The support member and the floppy disk were punched in form of a 3.5-type floppy disk. With these specimens erected at vertical position, the center of the disk was chucked by ring, and this was rotated at 60 rpm. A region in the range of 20 mm to 45 mm in radius from inner periphery was scanned using a laser displacement meter. A difference between a position where the distance between the disk and the displacement meter was at the shortest and a position where it is at the longest was obtained, and this was regarded as curl value.

(3) Planar Deviation

The floppy disk thus prepared was rotated on a Zip drive (Zip-100; Fuji Photo Film Co., Ltd.), and the planar deviation on the outermost periphery was determined using an optical fiber displacement meter.

The results of the evaluation on the specimens prepared in each of the above examples and the comparative example are shown in Table 1.

TABLE 1

| | External | | | Planar deviation | |
|---|---|---|---|---|---|
| Specimen | appearance | Curl | (mm) | (μm) | |
| Example 1 | Good | Good | 0.3 | Good | 40 |
| Example 2 | Good | Good | 0.4 | Good | 40 |
| Example 3 | Good | Good | 0.6 | Good | 48 |
| Comparative | Good | No good | 2.0 | No good | 120 |
| example | | | | | |

As it is evident in the results of the examples and comparative example given above, the examples prepared according to the present invention were satisfactory in both external appearance and curl value. On the other hand, in the comparative example where a film without lamination was used as the support member, the warping inherent in the film remained, and curl value and planar deviation were high.

By applying the present invention, it is possible to manufacture a support member, which has less susceptibility to warping and has less defects on the surface and the adhesion surface. The floppy disk produced using this support member has lower curl value.

What is claimed is:

1. A floppy disk, comprising a magnetic layer containing a ferromagnetic metal thin film at least on one surface of a flexible support member, whereby the flexible support member is designed in such structure that two heat-resistant resin films are bonded together with a hot-melt adhesion sheet.

2. A floppy disk according to claim 1, wherein the heat-resistant resin film is an aromatic polyimide film or an aromatic polyamide film.

3. A method for manufacturing a floppy disk, comprising the steps of forming a magnetic layer containing a ferromagnetic metal thin film at least on one surface of one film among two heat-resistant resin films by sputtering method, and of bonding together said two heat-resistant films with a hot-melt adhesion sheet.

4. A method for manufacturing a floppy disk, comprising the steps of forming a magnetic layer containing a ferromagnetic metal thin film at least on one surface of one film among two heat-resistant resin films by sputtering method, said two heat-resistant films are heated under vacuum condition to remove moisture contained in the heat-resistant resin films, and of bonding together the heat-resistant resin films with a hot-melt adhesion sheet under vacuum condition.

5. A method for manufacturing a floppy disk according to claim 3 or 4, wherein the heat-resistant resin film is an aromatic polyimide film or an aromatic polyamide film.
